(19) United States
(12) Patent Application Publication
(10) Pub. No.: US 2026/0364989 A1
(43) Pub. Date: Nov. 19, 2026

(54) ROLL STABILIZER

(71) Applicant: ZF FRIEDRICHSHAFEN AG, Friedrichshafen (DE)

(72) Inventors: Andre STIEGLITZ, Osnabrück (DE); Ingolf MÜLLER, Freimersheim (Pfalz) (DE); Joachim HOLZNER, Marl (DE); Holger BUBLIES, Osnabrück (DE)

(21) Appl. No.: 19/139,592

(22) PCT Filed: Nov. 30, 2023
(86) PCT No.: PCT/EP2023/083702

§ 371 Date: Jun. 16, 2025

(30) Foreign Application Priority Data
Dec. 19, 2022 (DE) 10 2022 213 861.9

(51) Int. Cl. B60G 21/055; B62D 33/06

(52) U.S. Cl. CPC B60G 21/0551; B62D 33/0604; B60G 2204/162; B60G 2206/427; B60G 2206/7101; B60G 2206/85

(57) ABSTRACT

A roll stabilizer with two bending supports extending parallel to one another in vehicle longitudinal direction and a torsion bar spring that extends between the two bending supports in vehicle transverse direction and which is connected at its two end portions to the respective bending support that is associated with it to be fixed with respect to rotation relative to it. A receptacle for the torsion bar spring and two bearing receptacles for bearings by which the bending supports are connected to a vehicle frame are formed at the bending supports. The respective bending support has a base frame wound from at least one continuous-fiber strand and which includes a continuous-fiber-reinforced thermoset as winding material. The receptacle and the bearing receptacles are formed by windings. The receptacle and/or the bearing receptacles to be wound around have a non-round outer contour. The wound base frame is embedded in a fiber-reinforced plastics compound.

### CROSS REFERENCE TO RELATED APPLICATIONS

This is a U.S. national stage of Application No. PCT/EP2023/083702 filed Nov. 30, 2023. Priority is claimed on German Application No. DE 10 2022 213 861.9 filed Dec. 19, 2022, the contents of which are incorporated herein by reference.

### BACKGROUND OF THE INVENTION

### 1. Field of the Invention

The disclosure is directed to a roll stabilizer.

### 2. Description of the Related Art

A roll stabilizer is known from WO 2018/095662 A1. The roll stabilizer described therein has two bending supports extending parallel to one another in longitudinal direction of the vehicle and a torsion bar spring extending between the two bending supports in transverse direction of the vehicle. The torsion bar spring is indirectly or directly connected at its two ends to the respective bending support of the two bending supports that is associated with it so as to be fixed with respect to rotation relative to it. A receptacle for the torsion bar spring and two bearing receptacles for bearings by which the bending supports are connected to a vehicle frame are formed at the bending supports. Both the torsion bar spring and the bending supports are made from a metal. The bending supports are solidly formed and comprise a casting material. As part of electromobility and increased efficiency, there are intensive efforts to appreciably reduce the mass of vehicles. Particularly in utility vehicles, an increase in the load capacity taking into account high mileage is of great interest. Further, there is a general effort to achieve a more uniform weight distribution of the axles of a vehicle so that the effort to economize on mass prioritizes the front axle of a vehicle over the rear axle of the vehicle.

### SUMMARY OF THE INVENTION

In view of the prior art described above, it is an object of one aspect the present invention to further develop a roll stabilizer of the type mentioned above which is characterized by a lower mass and is producible in a more cost-effective manner.

According to one aspect of the invention, a roll stabilizer is suggested which has two bending supports extending parallel to one another in longitudinal direction of the vehicle and a torsion bar spring extending between the two bending supports in transverse direction of the vehicle. The torsion bar spring is indirectly or directly connected at its two ends to the respective bending support of the two bending supports that is associated with it so as to be fixed with respect to rotation relative to it. A receptacle for the torsion bar spring and two bearing receptacles for bearings by which the bending supports are connected to a vehicle frame are formed at the bending supports. It is provided, according to the invention, that the respective bending support comprises a base frame which is wound from at least one continuous-fiber strand and which comprises a continuous-fiber-reinforced thermoset as winding material, the receptacle and the bearing receptacles are formed by windings, the receptacle to be wound around and/or the bearing receptacles to be wound around have a non-round outer contour, and the wound base frame is embedded in a fiber-reinforced plastics compound.

The mass of the bending supports is reduced and a more cost-effective production is achieved at the same time in that the base frame comprising continuous-fiber-reinforced winding material is embedded in a fiber-reinforced plastics compound. In this regard, it is particularly advantageous that the base frame comprising the continuous-fiber-reinforced thermoset as winding material experiences only very minor moisture absorption and degradation through thermal stresses compared with thermoplastics. The fiber-reinforced plastics compound in which the base frame is embedded takes on a supporting function. As result of the supporting function, in particular, kinking of individual windings of the at least one continuous-fiber strand which form the base frame is prevented. As a result of the combination of the wound base frame comprising the continuous-fiber-reinforced thermoset with the fiber-reinforced plastics compound enclosing the base frame, an increase in the mechanical load capacity of the respective bending support is achieved. Accordingly, it is possible to substitute the prior-art metal material for bending supports with a combination of different fiber-reinforced plastics whose respective specific advantages are combined. Aside from the savings in weight and the cost advantage, the construction of the bending supports according to the invention is also advantageous in view of the energy requirement during production. In particular, a prepreg or a towpreg, a pre-impregnated continuous-fiber strand with thermoset matrix, are used as continuous-fiber-reinforced winding material.

The plastics compound can preferably be short-fiber-reinforced, particularly by glass fibers. Both the winding material and the plastics compound can be reinforced by the same fiber material, but preferably with different fiber lengths. Alternatively, the at least one continuous-fiber strand and the plastics compound can contain reinforcing fibers of different materials. For example, the at least one continuous-fiber strand can contain carbon fibers, while the plastics compound is reinforced with glass fibers.

In particular, the receptacle and the one bearing receptacle can be arranged in a first end region of the bending support, and the other bearing receptacle can be arranged in the opposite, second end region of the bending support. The bearing receptacles of the bending supports which are arranged in the first end region oriented toward the torsion bar spring serve to support the roll stabilizer. The bending supports can be linked in each instance to the bearing receptacle arranged in the second end region by a bracket at a longitudinal rail of a vehicle frame.

Winding plies of the winding material which run in a looping manner, respectively, can preferably be arranged between the receptacle and the respective bearing receptacle and between the bearing receptacles of the bending support. Accordingly, connections can form with parallel-running strands of the at least one continuous-fiber strand between the receptacle and the bearing receptacle in the first region of the bending support, between the receptacle and the bearing receptacle in the second end region of the bending support and between the bearing receptacle in the first end region and the bearing receptacle in the second end region of the bending support. To this end, the at least one continuous-fiber strand which is wound around the receptacle and the respective bearing receptacles as looping winding plies is wound with a constant winding direction. The winding direction can be clockwise or counterclockwise. In so doing, the receptacle and the respective bearing receptacle and the two bearing receptacles respectively form pairs of deflecting points for the at least one continuous-fiber strand.

An adaptation to contour of the looping winding plies between the bearing receptacle in the first end region of the bending support and the bearing receptacle in the second end region of the bending support for reasons relating to installation space can be achieved by at least one deflecting element which is applied during the winding process in order to deflect the at least one continuous-fiber strand in part from a straight-line course occurring due to the winding tension.

Further, crisscrossing winding plies of the winding material can be arranged between the bearing receptacle in the second end region of the bending support and the respective opposite receptacle and bearing receptacle in the first end region and between the receptacle and bearing receptacle in the first end region. Accordingly, connections with diagonally running strands of the at least one continuous-fiber strand crisscrossing respectively in the region between the receptacle and/or the bearing receptacles can form between the receptacle or bearing receptacle in the first end region and the bearing receptacle in the second end region and the receptacle and bearing receptacle of the bending support. To this end, the at least one continuous-fiber strand is wound with an alternating winding direction. The receptacle and bearing receptacle in the first end region of the bending support and the bearing receptacle in the second end region of the bearing support form a pair of deflecting points for the at least one continuous-fiber strand from which the base frame is formed.

Further, the receptacle and the bearing receptacles can be wound around completely by a plurality of winding plies of the winding material in circumferential direction. The respective complete circumferential encirclement of the receptacle and bearing receptacles in the first end region of the bending support, respectively, by the at least one continuous-fiber strand results in an advantageous embodiment for structures in the bearing support that are loaded in tension as well as for structures in the bending support that are loaded in compression. A further advantage consists in that wear of the fiber-reinforced plastics compound is reduced. The continuous-fiber strand located thereunder or embedded therein can absorb higher mechanical loads without wear.

An advantageous development for the absorption of bending loads on the part of the bending support results in that looping strands of the at least one continuous-fiber strand are laid down in combination with crisscrossing strands of the at least one continuous-fiber strand.

It Is preferably provided to combine all three kinds of winding plies in order to limit the continuous-fiber reinforcement to force flows between the three connection points of bending support, receptacle and two bearing receptacles. In this regard, the winding around proceeds first with the diagonally running winding plies before the looping winding plies are wound.

In particular, it is provided that the base frame is completely cured before embedding in the plastics compound, particularly the thermoplastic plastics compound. A displacement of the windings of the continuous-fiber strand during the embedding process can be prevented in this way.

In particular, gaps can remain between the looping winding plies of the base frame and/or the crisscrossing winding plies of the base frame, these gaps being filled by the plastics compound, particularly the thermoplastic plastics compound, when the base frame is embedded. The advantage in dispensing with a solid construction of the base frame consists in that the continuous-fiber strand which is generally more cost-intensive need only be used to the extent required for supporting the loads in fiber direction. Further, it is key that gaps are formed between the diagonal winding plies of the at least one continuous-fiber strand and the looping winding plies of the at least one continuous-fiber strand. Further, the depositing of the winding plies is controlled in such a way that gaps into which the plastics compound can enter are formed inside of the crisscrossing winding plies and looping winding plies. Gaps inside of the crisscrossing winding plies can form, for example, due to the alternating winding direction. As a result of an alternating winding of looping winding plies and crisscrossing winding plies, gaps can be provided in a spaced manner between these winding plies, this spacing corresponding at most to the thickness of the fiber strand. Consequently, the crisscrossing winding plies and looping winding plies form larger surfaces compared to a compact winding. The gaps between and/or inside of the crisscrossing winding plies and looping winding plies make it possible to improve the positive engagement when embedding in the plastics compound. The larger surface improves the frictional engagement for connecting the at least one fiber strand to the plastics compound.

The receptacle and the bearing receptacles can preferably comprise profile component parts, particularly bushes, sleeves and/or collar sleeves. This can facilitate winding around the entirety of the base frame to form the receptacle and the bearing receptacles of the bending support. A further advantage in the use of profile component parts consists in that bearings can be glued into the profile component parts of the bearing receptacles. This applies equally to the profile component part of the receptacle into which the torsion polygon profile of the torsion rod spring can be glued. In contrast to the plastics compound in which the formed receptacle and formed bearing receptacles would be embedded if profile component parts were not used, gluing in a bearing or torsion bar spring can be more difficult because of the lower surface energy. A further advantage in the use of profile component parts emerges during the embedding process, particularly by injection molding, in that the profile component parts serve as positioning aids for the wound base frame. Further, the profile component parts can serve as a further protection against displacement or damage to the windings of the continuous-fiber strand and base frame, respectively.

At least one of the profile component parts can have an undercut. In this way, an undercut can be filled at least partially when embedding in the plastics compound so that a positively engaging connection results between the profile component part and the plastics compound.

According to a preferred further development, at least the profile component part of the receptacle can have at least one partially flattened outer lateral surface. This advantageous embodiment form allows occurring bending loads to be distributed on a larger supporting surface so that the bending load is absorbed by a larger contact surface and is introduced into the structure of the bending support of continuous-fiber-reinforced thermoset and fiber-reinforced plastics material. In particular, a polygonal configuration of at least one of the profile component parts is advantageous. Preferably, all of the profile component parts have a polygonal outer contour on which the at least one continuous-fiber strand is deposited. The polygonal configuration enables a better absorption of a torque transmitted from the torsion bar spring to the bending support. Further, the polygonal configuration makes it possible to direct compressive forces in two directions. The compressive force applied to the polygonal profile component part is divided into two force components corresponding to the inclination of the contact surface.

In particular, the torsion bar spring and/or the bearings can be bondingly connected to the respective profile component part. An advantage which becomes apparent when the torsion bar spring is mounted is the absorption of stresses caused by the deformation of torsion polygon profiles at end portions of the torsion bar spring when pressed into the profile component part of the receptacle of the respective bending support. The respective profile component part is embedded in the bending support free of stresses.

Alternatively, the torsion bar spring and/or the bearings can be connected to the respective profile component part by frosting in or pressing in.

The profile component parts of the receptacle and bearing receptacles around which the at least one continuous-fiber strand is completely wound over the entire circumference offer the possibility of implementing a connection of the torsion bar spring and/or of the bearings by frosting in, pressing in or gluing in, since the at least one continuous-fiber strand with thermoset matrix has a high surface energy for gluing as well as being suitable for absorbing very high circumferential stresses.

In particular, the receptacle and the bearing receptacles of the bending support can have a divergent height profile in transverse direction. The bending support has a three-dimensional structure.

According to a preferred further development, the wound base frame can be partially wound around by a spiral winding running in longitudinal direction of the bending support. Influence can be exerted on the subsequent component contour by the spiral winding. Accordingly, a waist can be produced by a spiral winding when necessary for reasons pertaining to installation space. Further, the spiral winding is useful for stabilizing the base frame when subsequently embedded in the plastics compound.

The wound base frame can preferably be embedded in a short-fiber injection molding material or SMC (sheet molding compound) material.

The invention is not limited to the indicated combination of features of the independent claims or of the claims dependent thereon. Further, it is also possible to combine individual features, as far as they arise from the claims, from the following description of preferred embodiment forms of the invention or directly from the drawings. When the claims refer to the drawings through the use of reference numerals, this is not intended to limit the protective scope of the claims.

### BRIEF DESCRIPTION OF THE DRAWINGS

An advantageous embodiment form of the invention which will be explained in the following is shown in the drawings. The drawings show:

FIG. 1 is a perspective view of a roll stabilizer for a driver's cab mount according to the prior art;

FIG. 2 is a schematic perspective view of a bending support;

FIG. 3 is a schematic partial cutaway view of the bending support according to FIG. 2;

FIG. 4 is a schematic view of a base frame of the bending support; and

FIG. 5 is a schematic view of the bending support with oval profile component parts.

### DETAILED DESCRIPTION OF THE PRESENTLY PREFERRED EMBODIMENTS

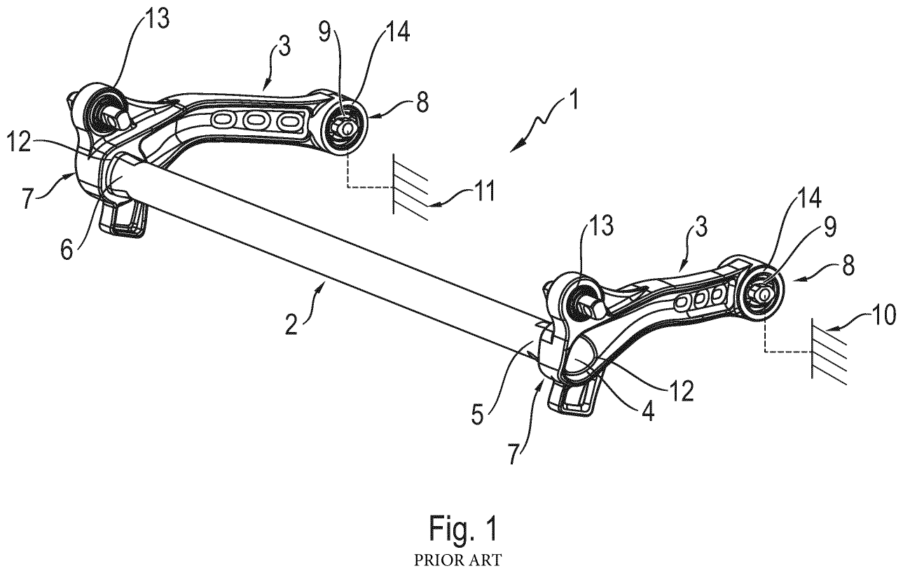

FIG. 1 shows a roll stabilizer 1 for a driver's cabin mount according to the prior art. The roll stabilizer 1 has a torsion bar spring 2, a bending support 3 being connected to the ends thereof via a non-round interference fit connection. The torsion bar spring 2 has a first polygonal end portion 5 and a second polygonal end portion 6 which are suitable for receiving stopper plugs 4 formed as polygon profiles, also known as obiforms. The torsion bar spring 2 may be formed, for example, as a torque tube. The bending supports 3 have a first end region 7 and a second end region 8. The bending supports 3 are connected in the second end region 8 in each instance by a bearing 9, in this instance, and preferably, a rubber bearing, to a vehicle frame 10, indicated merely schematically, and a driver's cab 11 of a motor vehicle. A receptacle 12 and a bearing receptacle 13 are arranged in the first end region 7 of the respective bending support 3 and a further bearing receptacle 14 for bearing 9 is arranged in the second end region 8 of the bending support 3. The solidly constructed bending supports 3 comprise a casting material, an aluminum casting alloy, a steel casting or a spherical graphite casting. The term “receptacle 12” describes a geometrical structure of the bending support 3 which serves to receive and fasten the first polygonal end portion 5 of the torsion bar spring 2 and the second polygonal end portion 6 of the torsion bar spring 2. Correspondingly, the term “bearing receptacle 13, 14” describes a geometrical structure of the bending support 3 which serves to receive and fasten the respective bearing 9 regardless of construction.

For reasons of simplicity and insofar as meaningful for the description of the subject matter, identical reference numerals are used in the following description for identical or functionally identical components or elements.

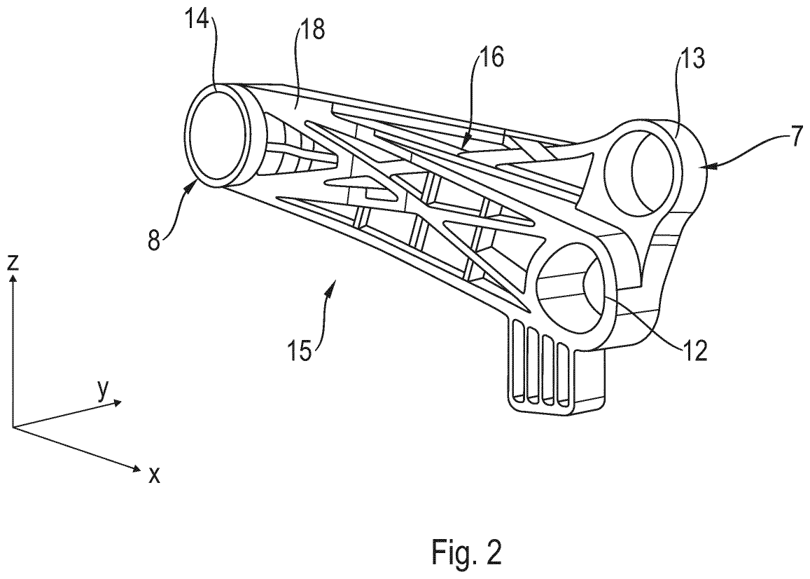

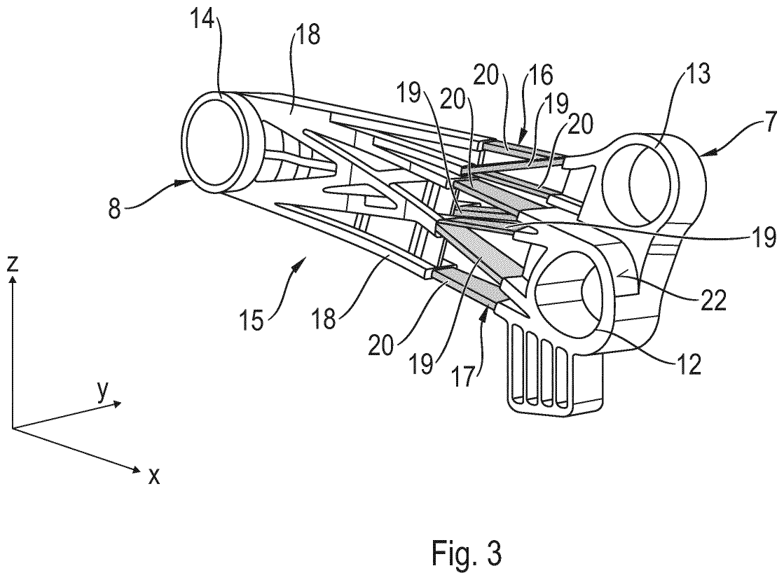

FIG. 2 shows a schematic perspective view of a bending support 15 according to one aspect of the invention which serves to receive the torsion bar spring 2 and the bearing 9, in this instance, and preferably, the rubber bearings. FIG. 3 schematically shows a partly cutaway view of the bending support 15 according to FIG. 2. The respective bending support 15 comprises a wound base frame 16. The base frame 16 comprises at least one continuous-fiber strand 17 of a continuous-fiber-reinforced thermoset as winding material. The receptacle 12 and the bearing receptacles 13, 14 are formed by different winding plies 19, 20, 21 of the at least one continuous-fiber strand 17. The base frame 16 has a three-dimensional winding structure. Receptacle 12 and bearing receptacles 13, 14 of bending support 1 have a divergent height profile in transverse direction y. The wound base frame 16 is embedded in a plastics compound 18 particularly a thermoplastic, fiber-reinforced, particularly short-fiber-reinforced, plastics compound 18. The plastics compound 18 encloses the exposed areas of the base frame 16 or of the different winding plies 19, 20, 21 of the at least one continuous-fiber strand 17, respectively.

As will be apparent from the depiction in FIGS. 2 and 3, at least the receptacle 12 to be wound has a non-round outer contour 22. The non-round outer contour 22 may be formed as a polygonal contour, for example, a triangular contour. Corners of the polygonal outer contour 22 are preferably rounded. Further, the sides of the polygonal outer contour 22 can be curved, for example. Alternatively, the non-round outer contour 22 can also be formed by an oval contour.

The winding plies 19 and 20 are partially visible in FIG. 3, wherein the winding plies 20 in each instance run in a loop-shaped manner between receptacle 12 and the respective bearing receptacles 13, 14. Accordingly, connections can be formed with looping strands of the at least one continuous-fiber strand 17 between receptacle 12 and bearing receptacle 13 in the first end region 7 of the bending support 15, bearing receptacle 13 in the first end region 7 and bearing receptacle 14 in the second end region 8 of the bending support 15, and receptacle 12 and bearing receptacle 14 in the second end region 8 of the bending support 15. The at least one continuous-fiber strand 17 is wound in a constant winding direction, for example, only in clockwise direction or only in counterclockwise direction, to form the looping winding plies 20. In so doing, receptacle 12 and the respective bearing receptacle 13, 14 of the bending support 15 and the two bearing receptacles 13, 14 of the bending support 15, respectively, form pairs of deflecting points for the at least one continuous-fiber strand 17. A plurality of continuous-fiber strands 17 with opposing winding directions may also form the looping winding plies 20.

Further, crisscrossing winding plies 19 of winding material are arranged between bearing receptacle 14 in the second end region 8 of the bending support 15 and the respective opposite receptacle 12 and bearing receptacle 13, respectively, in the first end region 7. Accordingly, connections are formed with diagonal strands and crisscrossing strands, respectively, of the at least one continuous-fiber strand 17 between receptacle 12 and bearing receptacle 13, respectively, in the first end region 7 and between bearing receptacle 14 in the second end region 8 and receptacle 12 and bearing receptacle 34 of the bending support 15. To this end, the at least one continuous-fiber strand 17 is wound with an alternating winding direction. Receptacle 12 and bearing receptacle 13, respectively, in the first end region 7 of the bending support 15 and bearing receptacle 14 in the second end region 8 of the bending support 15 form a pair of deflecting points for the at least one continuous-fiber strand 17.

Material accumulations can form in the crossover areas of the crisscrossing winding plies 19.

It can further be seen from FIG. 3 that receptacle 12 and bearing receptacles 13, 14 are wound around completely in circumferential direction by a plurality of winding plies 21. The respective complete circumferential encirclement of receptacle 12 and bearing receptacles 13, 14, respectively, by the winding plies 21 of the at least one continuous-fiber strand 17 results in an advantageous embodiment for structures in the bending support 15 that are loaded in tension as well as for structures in the bending support 15 that are loaded in compression. A further advantage consists in that wear of the fiber-reinforced plastics compound 18 is reduced. The continuous-fiber strand 17 located thereunder and embedded therein can absorb higher mechanical loads without wear.

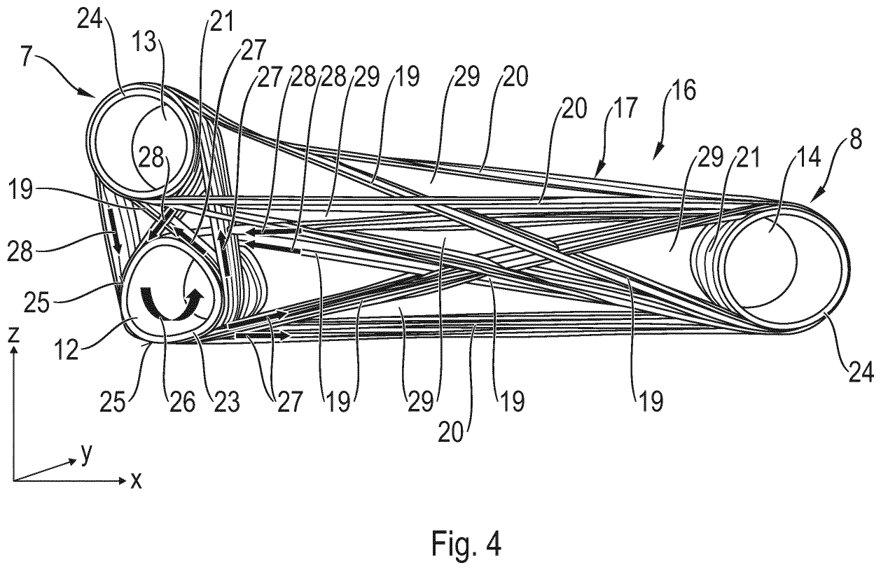

FIG. 4 schematically shows the base frame 16 of the bending support 15 according to the invention in a top view. Receptacle 12 and bearing receptacles 13, 14 can comprise closed profile component parts 23, 24 which are constructed in particular as bushes, sleeves and/or collar sleeves. Profile component parts 23, 24 are preferably made from metal. Profile component parts 23, 24 can be used instead of mandrels or the like for forming the receptacle 12 and bearing receptacles 13, 14 during the winding process of the base frame 16. At least profile component part 23 has a non-round circumferential contour. Profile component part 23 of receptacle 12 has at least one outer lateral surface 25 that is flattened in some portions thereof. The non-round circumferential contour can correspond to the non-round outer contour 22 of receptacle 12. In particular, profile component part 23 can have the circumferential contour of a Reuleaux triangle.

By way of example, FIG. 4 shows a torque 26, illustrated by an arrow, introduced into the bending support 15. The torque 26 is introduced from the torsion bar spring 2 into the bending support 15. The resulting forces which are introduced into the winding plies 19, 20 are symbolized by arrows 27 in the case of compressive forces and by arrows 28 in the case of tensile forces. The advantage resulting from the non-round circumferential contour of profile component part 23 and of the non-round outer contour 22 of receptacle 12 consists in that the forces resulting from the torque are divided into compressive forces 27 and tensile forces 28 which are introduced, respectively, into the winding plies 19, 20 at an angle. This is achieved as a result of the combination of crisscrossing and looping winding plies 19, 20. An advantageous embodiment of structures of the bending support 15 loaded in tension and structures of the bending support 15 loaded in compression results from the winding plies 21 which completely circumferentially enclose receptacle 12 and bearing receptacles 13, 14 and profile component parts 23, 24, respectively.

In particular, it is provided that the base frame 16 is completely cured before embedding in the plastics compound 18, particularly the short-fiber-reinforced thermoplastic plastics compound 18. Accordingly, a displacement of the fibers in the continuous-fiber strand 17 can be prevented during the embedding process.

In particular, it is provided that gaps 29 which are filled by the plastics compound 18 during the embedding of the base frame 16 remain between the looping and/or crisscrossing winding plies 19, 20 of the base frame 16. Dispensing with a solid construction of the base frame 16 particularly by compacting winding plies 19, 20 has the advantage that the continuous-fiber strand 17 which is generally more cost-intensive need only be used to the extent required for supporting the loads in fiber direction. It is key that gaps 29 of different sizes are formed between the crisscrossing winding plies 19 of the at least one continuous-fiber strand and the looping winding plies 20 of the at least one continuous-fiber strand. These gaps 29 are correspondingly filled with plastics compound 18 when embedded. The filling of the gaps 29 inside of and between the winding plies 19, 20 contributes to an improvement of mechanical stability. The embedding of material accumulations forming in the crisscrossing areas of the crisscrossing winding plies 19 additionally contributes to an improvement in mechanical stability.

The laying down of the winding plies 19, 20 is controlled in such a way that, additionally, gaps 29 into which the plastics compound 18 can enter are formed inside of the crisscrossing and looping winding plies 19, 20. Gaps inside of the crisscrossing winding plies 19 can form, for example, due to the alternating winding direction as they are laid down. Particularly in crisscrossing areas of the crisscrossing winding plies 19, these crisscrossing winding plies 19 can be spaced apart from one another, this spacing corresponding at most to the thickness of the fiber strand. Due to an alternating winding of crisscrossing and looping winding plies 19, 20, gaps 29 can be provided therebetween so as to be spaced apart from one another, this spacing corresponding at most to the thickness of the fiber strand.

In this way, larger surfaces are formed between and inside of the crisscrossing and looping winding plies 19, 20 compared to a compacted winding. The gaps 29 make it possible to improve the positive engagement when embedding the base frame 16 in the plastics compound 18. The larger surface improves the frictional engagement for connecting the at least one continuous-fiber strand 17 to the plastics compound 18.

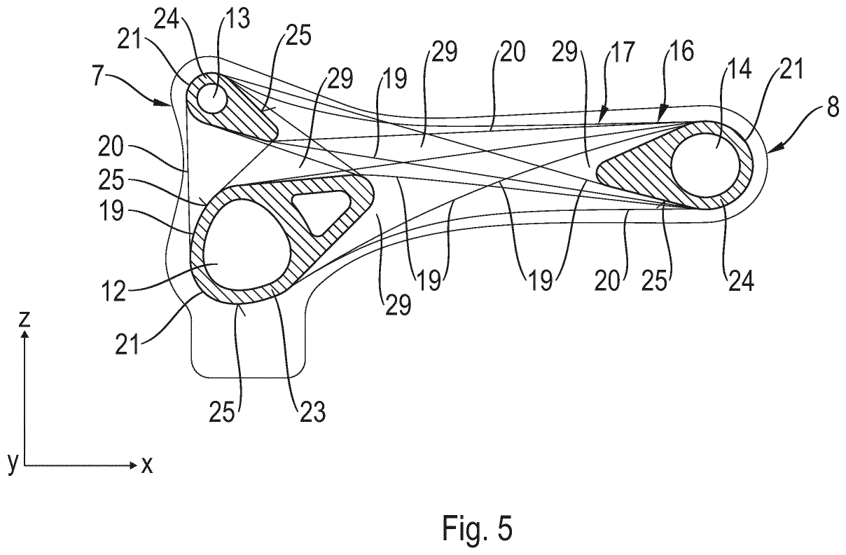

The diagram in FIG. 5 schematically shows the bending support 15 according to the invention with substantially oval profile component parts 23, 24. In order to improve the introduction of loads into the areas of receptacle 12 and bearing receptacles 13, 14 and to improve the absorption of locally acting multiaxial stresses, the profile component parts 23, 24 made from a metal are constructed to be oval. These oval profile component parts 23, 24 can likewise be wound around fully circumferentially by winding plies 21 of the continuous-fiber strand 17 to absorb the high circumferential forces resulting from the pressing in of the bearings 9. The outer lateral surfaces 25 of the profile component parts 23, 24 which are enlarged by the oval shape are characterized by an improved distribution of occurring bending loads on a broad surface area. The bending load can accordingly be absorbed by an enlarged surface and absorbed into the overall structure of the bending support 15 comprising the base frame 16 which is formed of the at least one continuous-fiber strand 17 and which is embedded in the short-fiber-reinforced plastics compound 18.

The profile component parts 23, 24 are constructed in particular as bushes, sleeves and/or collar sleeves. This can facilitate full circumferential winding to form receptacle 12 and bearing receptacles 13, 14 of the bending support 15 when winding the base frame 16. A further advantage in the use of profile component parts 23, 24 consists in that bearings 9 can be glued into the profile component parts 24 of the bearing receptacles 13, 14. This applies also to profile component part 23 of receptacle 12 into which the torsion polygon profile of the torsion rod spring 2 can be glued.

At least one of the profile component parts 23, 24 can have an undercut. In this way, an undercut can be at least partially filled when embedding in the plastics compound 18 so that there is a positively engaging connection between the respective profile component part 23, 24 and the plastic compound 18 surrounding the latter.

The receptacle 12 and bearing receptacles 13, 14 around which the at least one continuous-fiber strand 17 is completely wound further afford the possibility of implementing a connection by frosting in, pressing in or gluing in, since the continuous-fiber reinforcement with thermoset matrix of the continuous-fiber strand 17 has a high surface energy for gluing as well as suitability for absorbing very high circumferential stresses.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. A roll stabilizer comprising:
two bending supports extending parallel to one another in vehicle longitudinal direction;
a torsion bar spring which extends between the two bending supports in vehicle transverse direction and which is indirectly or directly connected at its two end portions to a respective bending support of the two bending supports that is associated with it to be fixed with respect to rotation relative to it,
a receptacle for the torsion bar spring are formed at the bending supports; and
two bearing receptacles for bearings by which the bending supports are connected to a vehicle frame are formed at the bending supports,
wherein each bending support comprises a base frame which is wound from at least one continuous-fiber strand and which comprises a continuous-fiber-reinforced thermoset as winding material,
wherein the receptacle and the bearing receptacles are formed by windings,
wherein the receptacle to be wound around and/or the bearing receptacles to be wound around have a non-round outer contour, and
wherein the wound base frame is embedded in a fiber-reinforced plastics compound.

17. The roll stabilizer according to claim 16, wherein the receptacle and a first bearing receptacle are arranged in a first end region of the bending support, and a second bearing receptacle is arranged in an opposite, second end region of the bending support.

18. The roll stabilizer according to claim 17, wherein winding plies of the winding material which run in a looping manner are arranged between the receptacle and the respective bearing receptacle of the bending support and between the bearing receptacles of the bending support.

19. The roll stabilizer according to claim 18, wherein crisscrossing winding plies of the winding material are arranged in each instance between the second bearing receptacle in the second end region of the bending support and the respective opposite receptacle and the first bearing receptacle, respectively, in the first end region and between the receptacle and the first bearing receptacle in the first end region.

20. The roll stabilizer according to claim 16, wherein the receptacle and the two bearing receptacles are wound around completely by a plurality of winding plies in circumferential direction.

21. The roll stabilizer according to claim 16, wherein the base frame is completely cured before embedding in the plastics compound.

22. The roll stabilizer according to claim 19, wherein gaps remain between the looping winding plies of the base frame and/or the crisscrossing winding plies of the base frame, these gaps being filled by the plastics compound.

23. The roll stabilizer according to claim 16, wherein the receptacle and the two bearing receptacles comprise profile component parts.

24. The roll stabilizer according to claim 23, wherein at least one of the profile component parts has

25. The roll stabilizer according to claim 23, wherein at least the profile component part of the receptacle has at least one partially flattened outer lateral surface.

26. The roll stabilizer according to claim 23, wherein the torsion bar spring and/or the bearings are bondingly connected to the respective profile component part.

27. The roll stabilizer according to claim 23, wherein the torsion bar spring and/or the bearings are connected to the respective profile component part by frosting in or pressing in.

28. The roll stabilizer according to claim 16, wherein the receptacle and the two bearing receptacles of the bending support have a divergent height profile in the transverse direction.

29. The roll stabilizer according to claim 16, wherein the wound base frame is partially wound around by a spiral winding running in the longitudinal direction of the bending support.

30. The roll stabilizer according to claim 16, wherein the wound base frame is embedded in a short-fiber injection molding material or SMC (sheet molding compound) material.

31. The roll stabilizer according to claim 23, wherein the profile component parts are bushes, sleeves and/or collar sleeves.
